(19) United States
(12) Patent Application Publication
(10) Pub. No.: US 2024/0252969 A1
(43) Pub. Date: Aug. 1, 2024

(54) AIR FILTER ASSEMBLY

(71) Applicant: Holley Performance Products, Inc., Bowling Green, KY (US)

(72) Inventors: Ethan Christopher Townsend, Rockfield, KY (US); Ryan Patrick Ringel, Bowling Green, KY (US); Nicholas Eugene Wolf, Bowling Green, KY (US)

(21) Appl. No.: 18/428,847

(22) Filed: Jan. 31, 2024

Related U.S. Application Data
(60) Provisional application No. 63/482,677, filed on Feb. 1, 2023.

(51) Int. Cl. B01D 46/00; B01D 46/24; B01D 46/52; B01D 53/04

(52) U.S. Cl. CPC B01D 46/0036; B01D 46/2403; B01D 46/521; B01D 53/0407; B01D 2253/34; B01D 2257/702; B01D 2259/4516; B01D 2275/201

(57) ABSTRACT

Present embodiments relate to an air filter assembly. More specifically, but without limitation, present embodiments relate to an air filter assembly with integrated hydrocarbon trap media disposed within the footprint or envelope, or internally of, the air filter. The air filter assembly positions a hydrocarbon trap media closely to an intake manifold, or conduit leading thereto, in order to capture any fuel vapor emission which may move opposite the normal flow direction. The hydrocarbon trap media is placed close to the engine and aligned with the airflow moving to the engine so that the vapor exiting the engine engages the hydrocarbon trap media when the engine is off, and airflow passes through the filter and along the hydrocarbon trap media when the engine is running.

### CLAIM TO PRIORITY

This non-provisional patent application claims priority to and benefit of, under 35 U.S.C. § 119(e), U.S. Provisional Patent Application Ser. No. 63/482,677, filed Feb. 1, 2023 and titled “Air Filter Assembly”, all of which is incorporated by reference herein.

### BACKGROUND

### 1. Field of the Invention

Present embodiments relate to an air filter assembly. More specifically, but without limitation, present embodiments relate to an air filter assembly with integrated hydrocarbon trap media within the footprint or envelope, or internally of, the air filter assembly.

### 2. Description of the Related Art

Air filters remove particulate from air flow entering an engine intake. These air filters provide clean air to the engine for combustion thereby inhibiting particulate from entering and damaging the engine internals.

During normal engine operation, the air flow may be drawn through the filter and then move into an intake manifold for mixture with air and delivery to combustion chambers.

When combustion engines for vehicles are turned off, there may be excess, unburned fuel vapor remaining along the intake path of the airflow. Without the negative pressure of air being pulled into the engine during engine operation, the fuel vapor can backflow toward the engine air filter and outward beyond the air filter. As this occurs, vapors can build in the engine compartment, or in an enclosed space where the vehicle is located.

In order to prevent this vapor from escaping the engine through the air filter to atmosphere, and thereby reduce carbon emissions, it may be desirable to capture the fuel vapor and reduce evaporative emissions of the hydrocarbons.

The information included in this Background section of the specification, including any references cited herein and any description or discussion thereof, is included for technical reference purposes only and is not to be regarded as subject matter by which the scope of the claims are to be bound.

### SUMMARY

The present application discloses one or more of the features recited in the appended claims and/or the following features which alone or in any combination, may comprise patentable subject matter.

The present embodiments provide an air filter assembly comprising an air filter and a hydrocarbon trap media disposed within the footprint of the air filter. The hydrocarbon trap media places the media close to either the engine intake manifold or a conduit connected to the intake manifold. In this way, the hydrocarbon trap media is closely located relative to a discharge location where unburned fuel vapor may exit the engine to atmosphere, when the engine is not operating.

According to some embodiments, a filter assembly comprises an air filter having a filter housing first end having a first diameter, a filter housing second end having a second diameter, the filter housing second end having a central opening and an axial component, a filter media extending between the filter housing first end and the filter housing second end. A carrier may be disposed in the air filter and connected to the filter housing first end, the carrier having a circular cross-section formed of a plurality of axial and circumferential members. The carrier and the filter housing first end being joined and the axial component having a radially inner surface with one or more beads configured to engage a combustion engine or a conduit connected thereto. A hydrocarbon trap media engaging one or more of the plurality of axial and circumferential members of the carrier, and being supported by the carrier, wherein the hydrocarbon trap is disposed within an envelope of the filter assembly.

In some embodiments, the carrier may be integrally joined with the filter housing first end.

In some embodiments, the carrier may further comprise anchors which are positioned within the filter housing first end, before or during curing.

In some embodiments, the filter housing first end may have a first side facing the filter housing second end.

In some embodiments, the filter assembly may further comprise a groove in the filter housing first end and in the filter housing second end, defining a location for the filter media.

In some embodiments, the filter media may be cylindrical in shape.

In some embodiments, the filter media may be frusto-conical in shape.

In some embodiments, the hydrocarbon trap media may be slidably positioned into the carrier without adhesives or fasteners.

In some embodiments, the carrier and the hydrocarbon trap media may be tamper resistant.

In some embodiments, the carrier may be injection molded, fabricated, or machined.

In some embodiments, the carrier may be cylindrical in shape.

In some embodiments, the carrier may be conical in shape.

In some embodiments, the hydrocarbon trap media may be defined by a rolled hydrocarbon sheet.

According to some embodiments, a method of forming a filter assembly comprises the steps of forming a first housing end, forming a second housing end, positioning a filter media between the first housing end and the second housing end, positioning a carrier through the second housing end toward the first housing end when the first housing end is being formed, the carrier having a hydrocarbon trap media thereon.

In some embodiments, the method may further comprise forming the hydrocarbon trap media of a hydrocarbon sheet material.

In some embodiments, the positioning may provide that the carrier is cantilevered from the first housing end.

In some embodiments, the filter assembly is cylindrical or frusto-conical in shape.

In some embodiments, the carrier extends axially to a location near the second housing end.

In some embodiments, the filter media is a pleated filter media.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein.

Therefore, no limiting interpretation of this summary is to be understood without further reading of the entire specification, claims and drawings, included herewith. A more extensive presentation of features, details, utilities, and advantages of the present teaching is provided in the following written description of various embodiments, illustrated in the accompanying drawings, and defined in the appended claims.

### BRIEF DESCRIPTION OF THE DRAWINGS

In order that the embodiments may be better understood, embodiments of an air filter assembly will now be described by way of examples. These embodiments are not to limit the scope of the claims as other embodiments of an air filter assembly will become apparent to one having ordinary skill in the art upon reading the instant description. Non-limiting examples of the present embodiments are shown in figures wherein:

FIG. 1 is a side schematic view of an air filter assembly having an integral hydrocarbon trap media therein and an example combustion engine;

FIG. 2 is an exploded view of the air filter assembly of FIG. 1 depicting the air filter, a carrier, and a hydrocarbon media trap;

FIG. 3 is an assembled perspective view of the air filter assembly of FIG. 1;

FIG. 4 is a side-section view of the air filter assembly; and,

FIG. 5 is a perspective view of the carrier with the hydrocarbon media trap shown partially therein and moving between portions of the axial and circumferential members;

FIG. 6 is an exploded perspective view of another embodiment of an air filter assembly;

FIG. 7 is a side-section of the air filter assembly of FIG. 6; and,

FIG. 8 is a flowchart showing an example method of assembly of the air filter assembly.

### DETAILED DESCRIPTION

It is to be understood that an air filter assembly is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

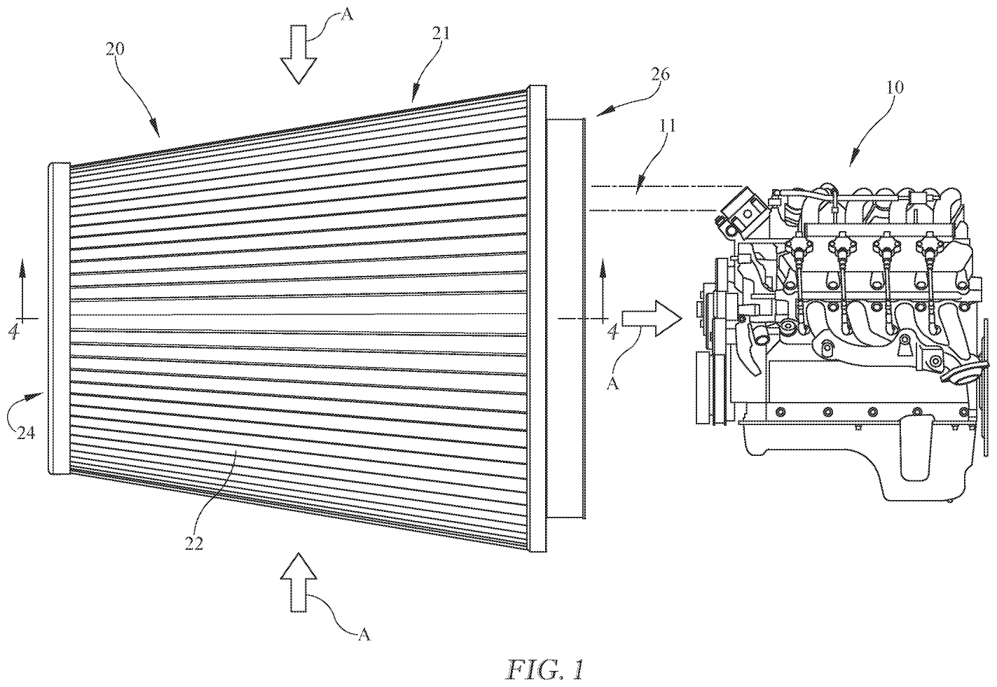

Referring now to FIGS. 1-8, embodiments of an air filter assembly is provided which comprises an integrated hydrocarbon trap media, disposed within the footprint or envelope, or otherwise internally, of the air filter assembly. The air filter assembly positions a hydrocarbon trap media closely to an intake manifold, or conduit leading thereto, in order to capture any fuel vapor emission which may move opposite the normal flow direction. The hydrocarbon trap media is placed close to the engine and aligned with the airflow moving to the engine so that the vapor exiting the engine engages the hydrocarbon trap media when the engine is off, and airflow passes through the filter and along the hydrocarbon trap media when the engine is running.

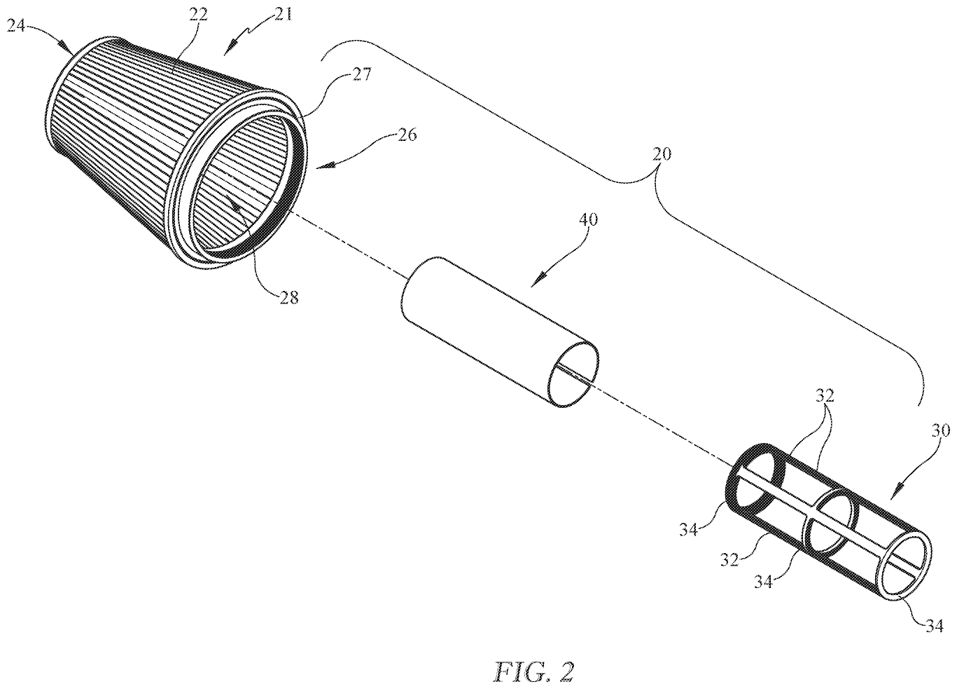

Referring now to FIG. 1, a side view of an air filter assembly 20 is shown adjacent to a schematic representation. The air filter assembly comprises a filter 21, a carrier 30 (FIG. 2), and a hydrocarbon trap media 40 (FIG. 2) therein. During operation of the combustion engine 10, a negative pressure is created which draws or pulls air A into and through the filter 21, through a filter media 22. The filter media 22 removes particulate greater than a preselected size from the air A as the air A moves through the filter media 22. In some non-limiting embodiments, the filter media 22 may be formed of a pleated material and in other embodiments may be unpleated. The filter media 22 may 22 may be formed of woven, non-woven, cotton, synthetic, polyester, or other fibers which only allow passage of particulate less than a preselected size. Such preselected size may be determined and then media selected for such specific size range. After air A passes through the filter media 22, the air moves into the engine 10 to allow for mixture with a fuel and subsequently, ignition.

The embodiment depicted of the air filter assembly shown in FIG. 1, is frustoconical in shape, but may alternatively be other shapes. For example, the air filter assembly may also comprise a cylindrical shape in some embodiments. In the depicted embodiment, the air filter assembly 20 has a filter housing first end 24 and a filter housing second end 26. In the depicted embodiment, the filter housing first end 24 has a circular cross-section and the filter housing second end 26 also has a circular cross-section. The first and second ends 24, 26 are shown as circular in cross-sectional shape but may vary if other shapes of the air filter 21 are utilized. Likewise, the housing first and second ends 24, 26 may be the same shape or may be differing shapes. The filter housing first end 24 is arranged generally parallel to the filter housing second end 26 and the first end 24 has a first side that is facing the filter housing second end 26.

The filter housing second end 26 is open for connection to the engine 10, either directly or indirectly, for example by a conduit 11. The air A therefore moves into the filter assembly 20 through the filter media 22, then passes to the engine 10 for further mixture with fuel vapor and subsequent combustion therein.

The filter housing first end 24 may comprise a closed end so that air cannot pass through the filter housing first end 24. Extending from the filter housing first end 24 may be the filter media 22, which is formed of a material that allows airflow therethrough and limits particulate which is greater than a preselected size from entering the combustion engine 10. The pleated media 22 has a first end and a second end which extend from the filter housing first end 24 to the filter housing second end 26. In some embodiments, the filter media 22 increases in diameter between the ends. The increase in diameter provides for increased surface area of media 22, which is desirable to allow for more airflow while decreasing pressure drop across the media 22.

While the first end 24 and the second end 26 are both of the same cross-sectional shape, in some embodiments, the shapes may differ. For example, and without limitation, one of the first end 24 and second end 26 may be circular and the other of the first end and second end 24, 26 may be square or some other polygonal shape.

The filter housing second end 26 is also circular in cross-section, in some embodiments. The second end 26 is connected to the combustion engine 10 or may be connected to a fluid conduit which is connected to the combustion engine 10. In either embodiment, the pleated media 22 is sealed to the filter housing first end 24 and the filter housing second end 26, which ultimately forces airflow to pass through the pleated media 22. Once inside the air filter assembly 20, the air A passes from inside the air filter assembly 20 out through the second end 26 of the air filter assembly 20. The media 22 may be sealed for example by an epoxy or an adhesive to the filter housing first and second ends 24, 26.

As shown in FIG. 1, the air A is shown as a double-line arrow moving into the pleated media 22 and outwardly through the filter housing second end 26, to the combustion engine 10. The combustion engine 10 may be, for example, a gasoline engine, a diesel engine, a propane engine, or may be any of various types of hydrocarbon burning engines.

Referring now to FIG. 2, an exploded perspective view of the air filter assembly 20 is shown. The air filter assembly 20 comprises an air filter 21, having the housing first end 24, the housing second end 26, and the pleated media 22. The air filter assembly 20 also comprises a carrier 30 which is exploded in the instant view, but when assembled, as shown in FIG. 1, is disposed within the air filter 21. The positioning of the carrier 30 within the air filter 21 allows for operational engagement of the hydrocarbon trap media 40 without requiring additional space, envelope, or size of the air filter while also providing for good exposure of the hydrocarbon trap media 40 to the vapor moving away from the combustion engine 10. Additionally, it positions a hydrocarbon trap media 40 closer to the engine 10 or conduit connecting the filter assembly 20 to the engine 10. This maximizes engagement with unburned fuel vapor.

The carrier 30 is shown exploded and is depicted as being cylindrical in shape. In some embodiments, the carrier 30 may have a tapered shape, for example to be conical or frusto-conical in shape. While both of these examples have circular cross-sections, other polygonal cross-sectional shapes may be utilized.

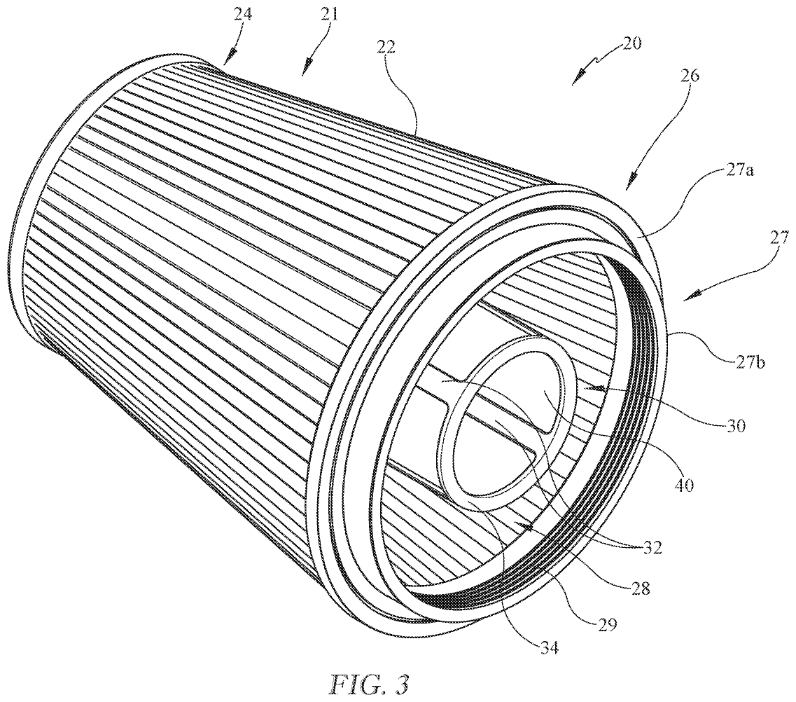

In the view depicted in FIG. 2, the housing second end 26 is shown having a hoop shape with opening 28. The opening 28 is defined by a flange 27 formed of an L-shaped cross-section and first and second components 27a, 27b (FIG. 3). Along an inner surface of the axial component of the flange 27, the housing second end 26 may comprise one or more beads, threads, or other attachment mechanism 29 (FIG. 3) for connecting the air filter assembly 20 to the engine 10 or the conduit 11 (FIG. 1) extending from the engine 10. Once connected to the engine 10 at the second end 26, the air A (FIG. 1) moves from within the filter 21, through the opening 28 of the second end 26.

The carrier 30 is sized to fit through the opening 28 in the filter housing second end 26. During assembly, the hydrocarbon trap media 40 may be positioned through the filter housing second end 26 and engage the filter housing first end 24 to integrally engage during formation of the filter housing first end 24.

The carrier 30 may be formed in a variety of ways. For example, the carrier 30 may be injection molded, blow molded, or may be fabricated or machined. Various types of structures may define the carrier 30 to allow retention of a hydrocarbon trap media 40. The carrier 30 may be joined to the filter housing first end 24 during formation of the filter housing first end 24. For example, if the filter housing first end 24 is a molded part, the carrier 30 may be formed with the first end 24, or the two may be joined during the curing process of the filter housing first end 24, so that the two parts become a single integral part. For example, in the orientation of FIG. 1, the carrier 30 may be cantilevered from the filter housing first end 24.

Referring still to FIG. 2, the carrier 30 may be formed of a plurality of members 32 which extend axially and two or more circumferential members 34 join the plurality of axially extending members 32. The instant embodiment provides a carrier 30 with a cylindrical shape and three circumferential members 34. The circumferential member 34 which is closest to the filter housing first end 24 may be joined therewith when assembled. As noted previously, the carrier 30 is shown as cylindrical in shape. However, other shapes may be utilized. Further, any such shape may be sized to fit through the opening 28 of the filter housing second end 26. Additionally, various other numbers of axial and circumferential members 32, 34 may be utilized.

Also shown in the exploded view is the hydrocarbon filter media trap 40. The media 40 is a sheet material that is rolled and held in place and shape by the carrier 30. The carrier 30 may form the groove 36 such that when the hydrocarbon trap media 40 is rolled, the hydrocarbon trap media 40 may be slidably positioned in an axial direction through the groove 36 of the carrier 30. The carrier 30 therefore defines a retaining structure which holds and supports the hydrocarbon trap media 40 in position during use.

Referring now to FIG. 3, the filter housing second end 26 is shown assembled in perspective view. From this view, it is shown that the second end 26 may be generally hoop-shaped by the flange 27 allowing airflow from inside the air filter assembly 20 to move out through the opening 28 of the filter housing second end 26. The filter housing second end 26 has a flange 27 of circular shape as previously discussed comprising a radially extending component 27a which is engaged by the filter media 22, and an axially extending component 27b which extends from the radially extending component 27a. The axially extending component 27b additionally may comprise one or more beads or threads 29 or other attachment mechanisms on an inner surface or outer surface for engagement with the engine 10 or a fluid conduit of the engine 10. The beads 29 may for example provide frictional engagement between the air filter assembly 20 and the engine or engine conduit to which the air filter assembly 20 connects. The beads 29 may also provide sealing engagement between the air filter assembly and the engine or engine conduit to inhibit air from by-passing the filter 21 and entering the engine 10. The filter housing second end 26 may comprise any of numerous materials that is molded, stamped, forged, machined, and which are impermeable airflow to pass through the material.

The filter housing second end 26 is also shown being open. This allows for connection to the engine 10 either directly or indirectly, and allows a location for air A flow to exit from inside the air filter assembly 20 toward the engine 10. In this way, one skilled in the art will realize that as air passes through the filter media 22, any particulate greater than a preselected size will be trapped on or in the filter media 22 and cleaner air A exits from the opening 28 in the filter housing second end 26.

Also shown in this view, through the opening 28 in the filter housing second end 26 is the carrier 30. The carrier 30 is shown with the hydrocarbon trap media 40. The hydrocarbon trap media 40 may be rolled, pressed, porous or other forms, or combinations of any of the preceding. The hydrocarbon trap media 40 may absorb hydrocarbons when the engine is turned off. Additionally, the hydrocarbon trap media 40 may also de-sorb the hydrocarbons so that when the engine is turned on, the vapors are moved from the media 40 into the engine for combustion, and therefore reduce waste.

The carrier 30 may comprise the plurality of members 32, 34 which form a shape which supports the hydrocarbon trap material 40 in a preselected shape. For example, in the instant depiction, the carrier 30 may comprise the plurality of axial members 32 and the plurality of circumferential members 34 which define a cylindrical shape. The hydrocarbon trap media 40 may therefore be formed as a sheet material in some embodiments and may be rolled into a cylindrical shape to cooperate with the shape defined by the carrier 30.

In some embodiments, the hydrocarbon trap media 40 is generally a sheet-like material that may be rolled, or placed into configurations, and positioned on, around, or within the carrier 30. The carrier 30 is shown having a circumferential member 34 at one end and plurality of axially extending members 32 to define an open framework that allows airflow to pass through and which will support hydrocarbon trap media 40. In the instant embodiment, the hydrocarbon trap media 40 may be rolled and inserted within the carrier 30 for support. The carrier members 32, 34 may also be arranged to form alternate shapes such as square cross-sections, pentagonal cross-sections, hectagonal cross-sections, or others. Various cross-sections may be utilized and it may be desirable to form them of varying shape to increase surface area and therefore provide the added surface area for improved engagement with hydrocarbons. The carrier 30 is also sized to fit through the opening 28 of the flange 27 so that carrier 30 may fit within the filter 21.

As further shown in the view, the carrier 30 is floating within the air filter assembly 20. The carrier 30 extends from the filter housing first end 24 toward the filter housing second end 26. In the view of FIGS. 1-3, the carrier 30 may be cantilevered from the filter housing first end 24 and float within the filter assembly 20 at the second end 26. The carrier 30 extends to the filter housing second end 26, so as to position the carrier 30 and hydrocarbon trap media 40 closely to the engine or to the fluid conduit to which the air filter assembly 20 is connected.

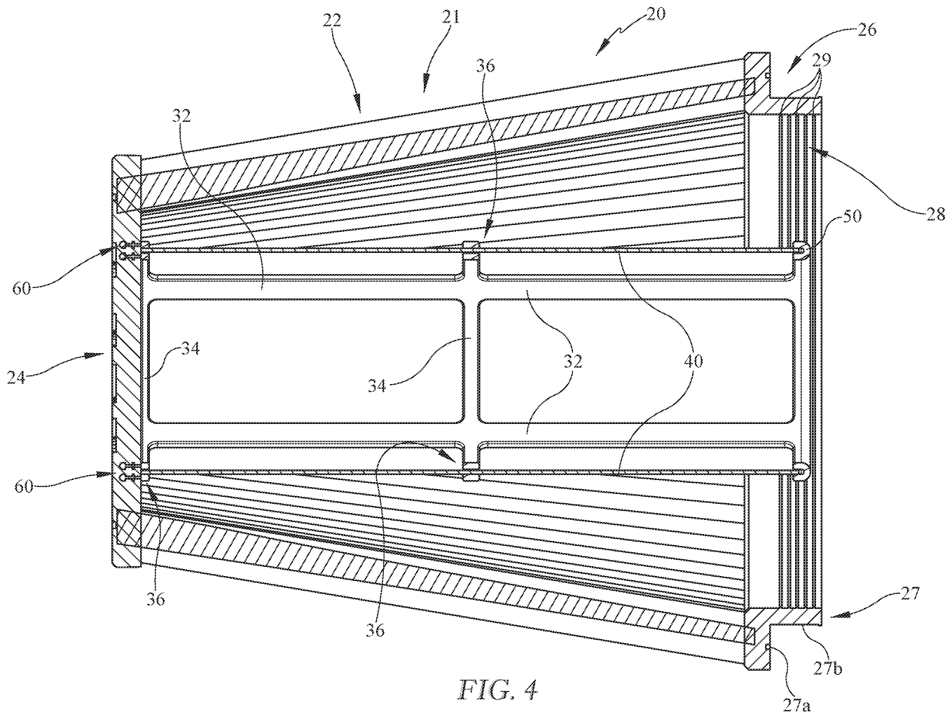

Referring now to FIG. 4, a side section view of the air filter assembly 20 is shown. The view shows the air filter assembly 20 sliced along an axially extending vertical plane, revealing the interior of the air filter assembly 20. The carrier 30 is shown engaging the filter housing first end 24. With the hydrocarbon trap media 40 extending the full axial length of the carrier 30, the media 40 therefore also extends from the filter housing first end to the filter housing second end 26. This configuration places the hydrocarbon trap media 40 close to the beads 29 of flange 27. Accordingly, the hydrocarbon trap media 40 is positioned close to the engine or conduit connection to the air filter assembly so that the media 40 is presented to the fuel vapor reversing in movement toward the air filter assembly 20. In this way, the hydrocarbon trap media 40 has a higher chance of engaging with, or exposure to, the unburned fuel vapor.

For brief explanation, when a combustion engine 10 is not operating, fuel vapor may move away from the engine (opposite to movement during operation). It is desirable to contain such fuel vapor before the vapor passes through the filter to atmosphere. When the engine is turned off, the hydrocarbon trap media 40 may capture the fuel vapor moving out of the engine, as opposed to the fuel vapor escaping through the filter media to atmosphere.

With reference still to FIG. 4, the carrier 30 is formed and integrally joined to the filter housing first end 24. For example, if the filter housing first end 24 is a molded part, the carrier 30 may engage the filter housing first end 24 during the molding process, or may engage the filter housing first end 24 when the first end is being cured but is still molten. In this way, the carrier 30 and the filter housing first end 24 become a single part upon curing and this renders the structure tamper resistant because the carrier 30 cannot be removed from the air filter 21. Alternately, other manufacturing methods may occur which provide engagement and which limit airflow between the hydrocarbon trap media 40 and the filter end first housing 24.

With the carrier 30 secured to the filter housing first end 24, the section view shows the carrier 30 extending to the filter housing second end 26. The carrier 30 may 30 may extend to the beads 29 portion of the axial wall, or axial component. As one skilled in the art will recognize, this places the corresponding end of the carrier 30 near the fluid conduit or engine 10 to which the air filter assembly 20 is connected. This also positions the hydrocarbon trap media 40 near the discharge point of the vapor and increases the likelihood of engagement between the vapor and hydrocarbon trap media 40.

The end of the carrier 30 may include a seal or gasket material 50 in order to engage the end of the fluid conduit or the engine, depending on whether there is a direct or an indirect connection.

With the section view, the relationship between the filter housing second end 26 and carrier 30 may also be seen. The filter housing second end 26 has a larger diameter opening 28 than the carrier 30. During operation of the engine, as air flow A moves through filter media 22 and the air A may pass around the outside of the carrier 30 and hydrocarbon trap media 40. Accordingly, the air A flows through the space between the filter housing second end 26 and the carrier 30, and further into the engine 10 for combustion. Oppositely, when the engine is shut off, any remaining fuel vapor may reverse and pass from the engine through the position where the carrier is located so that some or all of the vapor passes into the carrier 30 and engages the hydrocarbon trap media 40.

The section view also depicts a view of the relationship between the diameters of the hydrocarbon trap 40 and the filter housing second end 26. The gap between the parts provides that the airflow to the engine can occur and is not restricted when the engine is operating. However, the diameter of the carrier 30 may also be defined to maximize the surface area of the hydrocarbon trap media 40 to increase the likelihood of engagement with fuel vapor while also not impeding the air flow to the engine during, for example, maximum throttle.

With regard to the diameter relationship between the filter housing second end 26 and the carrier 30, various ratios may be used. One boundary for the design is that the carrier 30 should not be so large that it negatively affect the functionality of the air filter 21 so that the engine 10 does not receive adequate air flow. An alternate boundary for the design is to maximize engagement of fuel vapor with the hydrocarbon trap media 40.

Referring still to FIG. 4, the section also reveals the interior engagement of the carrier 30 and the filter housing first end 24. The carrier 30 includes anchors 60 which extend into the filter housing first end 24 when the first end 24 is molten for example. With the anchors 60 extending into the filter housing first end 24 and upon curing, the anchors 60 fix the carrier 30 to the filter housing first end 24. As shown therefore, the carrier 30 and the hydrocarbon trap media 40 are cantilevered from the filter housing first end 24. Likewise, the carrier 30 and the filter housing first end 24 are formed as a single structure.

Also shown more clearly at the opposite end of the air filter assembly 20 are the beads 29 of the filter housing second end 26. The beads 29 provide a sealing engagement with the engine 10 (FIG. 1) or engine conduit 11 (FIG. 1) between the engine 10 and the filter assembly 20. As may be understood from this view, the beads 29 represent an area where the filter assembly 20 engages another connecting part, such as a conduit for air flow to the engine. The carrier 30 extends to the beads 29 and therefore positions an end of the hydrocarbon trap media 40 at an end of the filter assembly 20 where the engine or conduit discharge is located.

Further shown in this section view, one or more of the circumferential members 34 may have a groove 36 through which the hydrocarbon trap media 40 is disposed. The groove 36 allows slidable positioning of the hydrocarbon trap media 40 therethrough. Thus the hydrocarbon trap media 40 is supported by the carrier 30. Additionally, the members 32 may be located inwardly, outwardly, or both of the media 40 and when the engine 10 is operating normally, the members 32 and the groove 36 preclude the media 40 from being pulled into the engine by negative pressure.

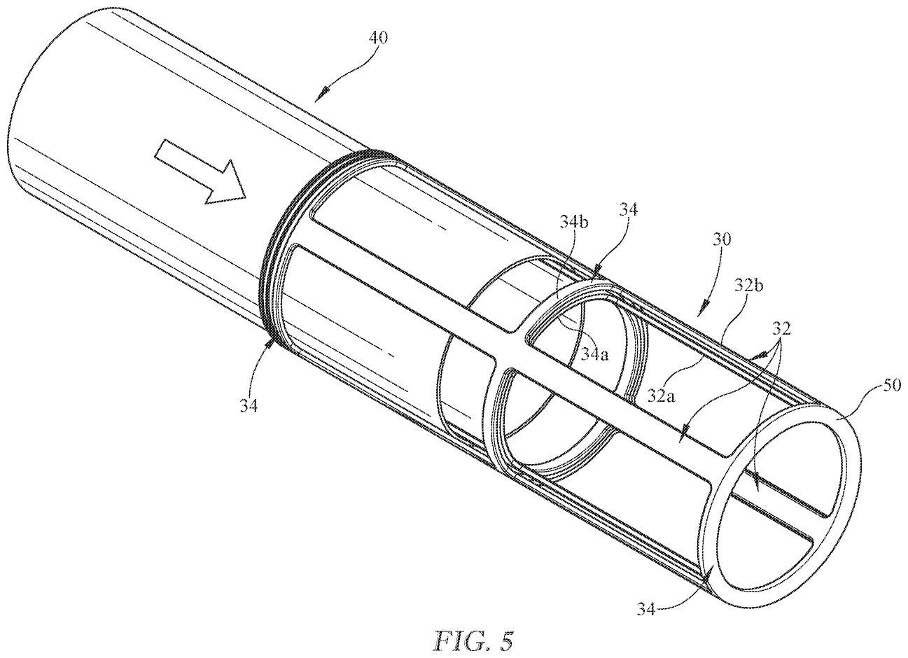

With reference now to FIGS. 3-5, the members 32, 34 either individually or both may have radially outer members and radially inner members which provide for the groove to be located therein. As shown in FIG. 4, there may be a radially inner and radially outer portion formed by the circumferential member 34. With additional reference to FIG. 3 again, the axial members 32 may also comprise radially inner and radially outer members so that the members also define a groove between which the hydrocarbon trap media 40 may be located. As shown more clearly in FIG. 5, the members 32, 34 each comprise a radially inner portion or component 32a, 34a and radially outer portion or component 32b, 34b so that the groove 36 is formed between each of the portions or components. This defines the groove 36 in the members 32, 34 that allows the slidable positioning of the hydrocarbon trap media 40. Additionally, with the axial and circumferential components 32a, 32b, 34a, 34b on either side of the media 40, the media is supported from fluid flows so that the media is not sucked into the engine.

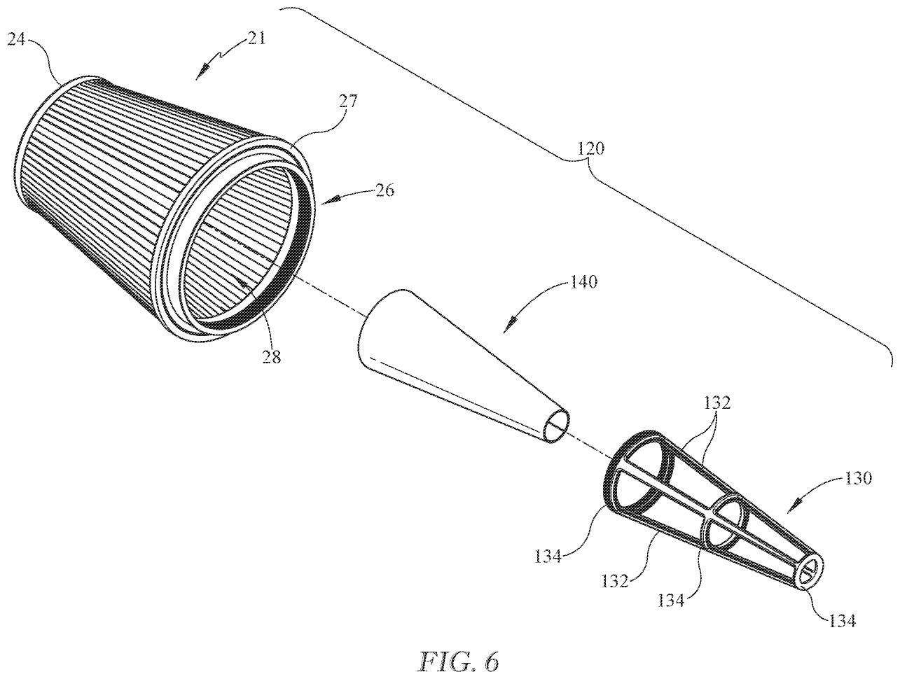

Referring now to FIG. 6, a second embodiment of the air filter assembly is depicted. In the exploded view, the carrier 130 and the trap media 140 are shown exploded from the filter 21. The carrier 130 has a conical shape, as opposed to the cylindrical shape of the previous embodiment. The carrier 130 has angled axially extending members 132 and circumferential member 134. Due to the conical shape of the carrier 130, the circumferential members 134 are of differing diameters. The members 132, 134 define a frame through which air can pass but which supports the hydrocarbon trap media 140.

The instant frame allows fuel vapor to pass from the engine 10 through the carrier and engage the hydrocarbon trap media. Likewise, the smaller conical end of the carrier 130 provides for improved airflow from within the air filter assembly 120 to the engine 10 during engine operation.

Still further, the hydrocarbon trap media 140 is shown in a rolled conical form. In the depicted structure, the trap media 140 may be unrolled and then placed through retaining grooves in the members 132, 134 or both. Alternatively, the media 140 may also be disposed in over the conical carrier 130 in a roller form along the outside of the angled axial members 132.

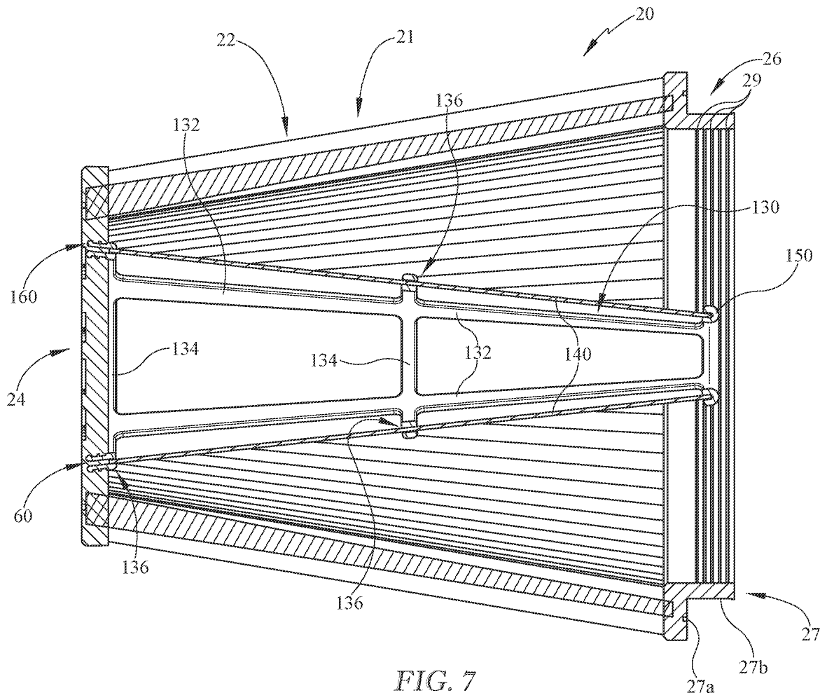

Referring now to FIG. 7, a side-section view of the air filter assembly of FIG. 6 is shown. The side-section view provides a view of the carrier 130 disposed within the air filter 21. The carrier 130 may include anchors 160 which are disposed within or integrally engage the closed end housing 24 of the air filter. As in the previous embodiment, the carrier 130 is cantilevered from the first housing 24 when the filter 21 is oriented as shown. Moving left to right across the carrier 130, the diameter changes so that the smaller end 150 of the conical carrier shape is disposed at the larger end of the air filter 21. Additionally, the smaller end 150 of the carrier 130 is shown extending to an axial position which is near the beads 29, which engage the conduit 11 or engine 10.

Also shown in the section view, the air filter 21 may comprise a groove or slot 136 disposed on one or more of the axial members 132 and/or the circumferential members 134. The groove 136 allows passage of the hydrocarbon trap media 140 so as to extend in the axial direction of the carrier 130 but be held in place by the groove 136 of the carrier 130.

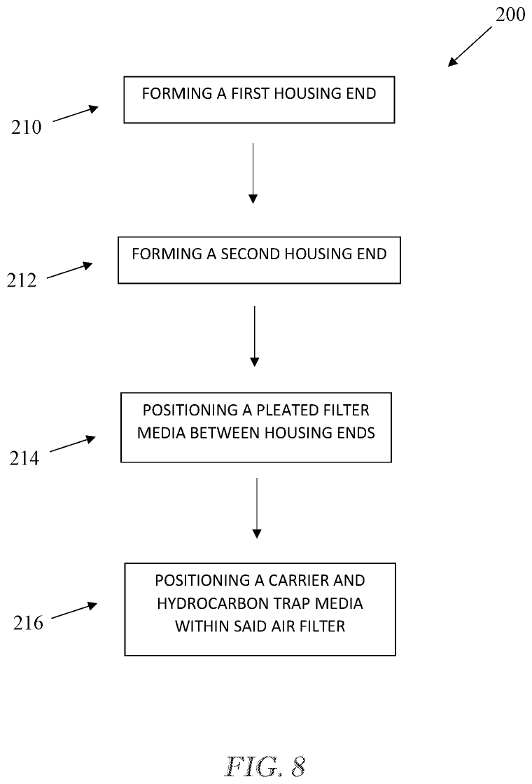

With reference now to FIG. 8, a flow chart 200 is provided which describes the assembly of the air filter assembly. In one step 210, a first housing end is formed. In another step 212, a second housing end is formed. In a subsequent step 214, a media filter is positioned between the first and second housing ends. This defines the air filter as previously described. In a next step 216, the carrier 30, 130 including the hydrocarbon trap media 40 is positioned in the air filter. This includes engagement with the first housing end as previously described.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration, other measurement, or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method. Additionally, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A filter assembly, comprising:
an air filter having:
a filter housing first end having a first diameter;
a filter housing second end having a second diameter, said filter housing second end having a central opening and an axial component;
a filter media extending between said filter housing first end and said filter housing second end;
a carrier disposed in said air filter and connected to said filter housing first end, said carrier having a circular cross-section formed of a plurality of axial and circumferential members;
said carrier and said filter housing first end being integrally joined;
said axial component of said filter housing second end having a radially inner surface with one or more beads configured to engage a combustion engine or a conduit connected thereto;
a hydrocarbon trap media disposed on a radially inward side of said members of said carrier;
wherein the hydrocarbon trap media is disposed within an envelope of said filter assembly.

2. The filter assembly of claim 1, said carrier being integrally joined with said filter housing first end.

3. The filter assembly of claim 2, said carrier further comprising anchors which are positioned within said filter housing first end, before or during curing.

4. The filter assembly of claim 1, said filter housing first end having a first side facing said filter housing second end.

5. The filter assembly of claim 3, further comprising a groove in said filter housing first end and in said filter housing second end, defining a location for said filter media.

6. The filter assembly of claim 2, said filter media being cylindrical in shape.

7. The filter assembly of claim 2, said filter media being frusto-conical in shape.

8. The filter assembly of claim 1, said hydrocarbon trap media being slidably positioned into the carrier without adhesives or fasteners.

9. The filter assembly of claim 1, wherein said carrier and said hydrocarbon trap media are tamper resistant.

10. The filter assembly of claim 1, said carrier being injection molded, fabricated, or machined.

11. The filter assembly of claim 10, said carrier being cylindrical in shape.

12. The filter assembly of claim 1, said carrier being conical in shape.

13. The filter assembly of claim 1, said hydrocarbon trap media being defined by a rolled hydrocarbon sheet.

14. A method of forming a filter assembly, comprising the steps of:
forming a first housing end;
forming a second housing end;
positioning a filter media between said first housing end and said second housing end;
positioning a carrier through said second housing end toward said first housing end when said first housing end is being formed, said carrier having a hydrocarbon trap media thereon.

15. The method of claim 14, further comprising forming said hydrocarbon trap media of a hydrocarbon sheet material.

16. The method of claim 14, said positioning providing that said carrier is cantilevered from said first housing end.

17. The method of claim 14, wherein said filter assembly is cylindrical or frusto-conical in shape.

18. The method of claim 14, wherein said carrier extends axially to a location near said second housing end.

19. The method of claim 14, wherein said filter media is a pleated filter media.
